(19) United States
(12) Patent Application Publication
(10) Pub. No.: US 2021/0352969 A1
(43) Pub. Date: Nov. 18, 2021

(54) Soft Fabric Garment Having Stiff Fabric Structural Elements

(71) Applicant: Fortiac Corporation dba Téchin New York, New York, NY (US)

(72) Inventor: Téchin Kraikhajornkitti, New York, NY (US)

(73) Assignee: Fortiac Corporation dba Téchin New York, New York, NY (US)

(21) Appl. No.: 17/273,993

(22) PCT Filed: Sep. 7, 2019
(86) PCT No.: PCT/US19/50117

§ 371 Date: Mar. 5, 2021

Related U.S. Application Data
(60) Provisional application No. 62/728,508, filed on Sep. 7, 2018.

(51) Int. Cl. A41B 7/08; D06M 17/00; A41B 3/06; A41D 27/06

(52) U.S. Cl. CPC A41B 7/08; A41D 27/06; A41B 3/06; D06M 17/00

(57) ABSTRACT

A garment made from a soft fabric with stiff fabric support elements. A first fabric forms the primary garment, and at least one support panel formed of a second fabric stiffer than the first fabric is affixed with a selected portion of the primary garment to provide additional structure to a feature of the selected portion.

### TECHNICAL FIELD

This disclosure relates generally to the field of garment manufacture, and more specifically, to the use of stiff fabric to provide structural support to important areas of a garment made with softer fabrics.

### BACKGROUND

In clothing, some of the most desirable and softest fabrics have the least amount of stiffness or structural support. The softness of touch in particular often scales directly with the rigidity of the fabric. One of the most popular and sought after soft fibers is cashmere, a fiber with little rigidity that tends to drape over the body rather than form itself as a garment. The appearance of the end garment is therefore less clean and allows for the form of the person's body underneath to be displayed.

Men's clothing in particular has a long tradition of valuing stiff construction. One example of this is the canvas that goes into high end men's suiting. Because the suiting itself is delicate and soft, a horsehair canvas is added in between the layers of fabric to add an additional form of stiffness to the body and lapels. The resulting suit presents much cleaner appearance that masks the shape of the body underneath.

This desirable effect of canvas does have its underlying drawbacks however. One is that it makes the garment much more difficult to clean and manage. If the canvas is attached with adhesive, there can be a bubbling effect on the outer layer of the garment if too much heat is applied during the cleaning process as the adhesive weakens. An alternative is to canvas by hand, which is a long and laborious process requiring years of training to fully master and a great deal of economic investment made into each garment. Another drawback is that it adds considerable weight and warming properties to the garment. The canvas can often be heavier than the lining or body fabric. An additional difficulty is that the canvas needs to match the relative weight of the body fabric or else puckering on seams can present itself. The additional layer can also add additional warming properties which may not always be valuable as it can additionally limit the wearability of the garment in differing climates.

Another drawback is that canvas construction gives the designer much less control in which areas they would like to drape versus which areas which need the stiffer construction. Part of the value in some soft fibers, such as cashmere, silk, or mohair, is their ability to fall naturally versus a stiff fabric or addition which lacks that tendency.

Comfortability is another area of contention as a fully canvassed jacket is often referred to as being like a suit of armor. There is less ability to move around and less flexibility in the garment as the resulting garment is quite stiff.

For these reasons, it would be valuable to have a method to structure garments in a way that facilitates the manufacturing process and gives more overall freedom for the body fabric to drape while still presenting a clean appearance that conceals the body shape underneath the garment.

### BRIEF DESCRIPTION OF THE DRAWINGS

FIG. 1 is a front plan view of a jacket having a stiff fabric or leather incorporated undercollar, under center front placket, and under cuffs.

FIG. 2 is a side plan view of the jacket shown in FIG. 1.

FIG. 3 is a rear plan view of the jacket shown in FIG. 1.

### DETAILED DESCRIPTION

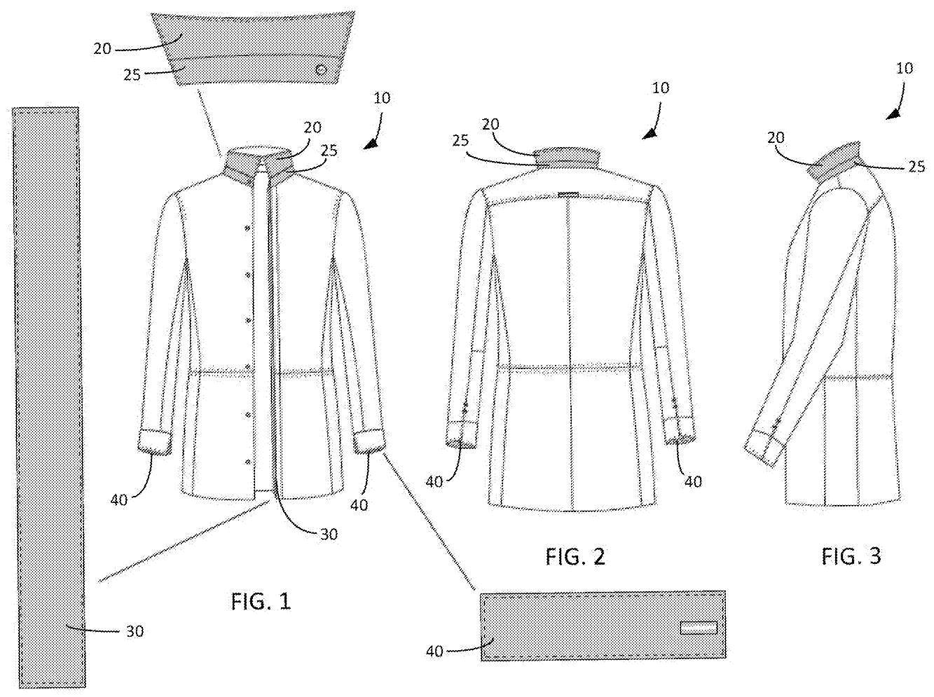

FIGS. 1-3 illustrate the front, left side, and rear views of a basic garment 10, namely, a jacket, with the addition of stiff fabrics or leather panels in key areas. These stiff fabric panels can be of any fabric content or leather type as long as they provide an additional element of structure that would be greater than the body fabric of the pieces to which they are attached. These panels can be largely hidden while normally wearing the garment, especially if a hidden center front placket can be added to the garment as seen in FIG. 1. The structural elements do not need to be matching in color or texture to the main body fabric, but also can be contrasting color at the discretion of the garment's designer.

When talking about the stiffness between the stiff fabric and the soft fabric, a metric is established with a standard method for testing and measuring the stiffness properties of fabrics as generally used in the fabrics industry, namely, ASTM D1388 entitled Standard Test Method for Stiffness of Fabrics.” The standard describes a “Cantilever Test” in which the principle of cantilever bending is used to test the fabric under its own mass to measure the average bending length in both the length (weft) direction and the width (warp) direction of the fabric. The less a material bends in the warp/weft, the less it will fall or drape when standing and thus is more stiff Therefore, combining a second fabric having measurably more stiffness with a primary garment made from a first “softer” fabric, the second fabric will act as a structural support for the first fabric and create less drape on the structurally supported elements.

For example, the combination of a cashmere fabric with stiff leather support elements for key features creates a desirable structure. The cashmere fabric has an average bending length of 2.53 cm in the length direction and an average bending length of 3.13 in the width direction. The leather has an average bending length of 4.04 cm in the length direction and an average bending length of 4.06 in the width direction. This particular combination of a stiff fabric with a soft fabric, both tested in accord with the standard, presents a differential of 0.9 cm in the bending width direction (warp) between the two fabrics and a differential of 1.5 cm in the bending length direction (weft) between the two fabrics. The width differential represents a 30% increase in average bending length for the stiff fabric relative to the soft fabric, while the length differential represents a 60% increase in average bending length for the stiff fabric relative to the soft fabric. The larger the length and width at which a fabric bends under the ASTM D1388 Cantilever Test, the stiffer the fabric. Thus, in this example, the leather is measurably stiffer than the cashmere by 30% in the weft and 60% in the warp.

In general, the primary garment is made from a soft fabric, such as cashmere, silk or mohair. One or more key portions of the primary garment are provided with a support element such as a panel made from a stiffer fabric to give additional structure and stiffness to the key portion of the primary garment, such as a collar support, a collar stand, a cuff support, a placket, or any other desired support feature for the primary garment. The second fabric that forms the support panel is measurably stiffer by at least approximately fifteen percent than the first fabric that forms the primary garment. More specifically, the stiffer second fabric will have increased stiffness in both warp and weft, measured in accord with ASTM D1388 as an increased average bending length in both the width and length directions relative to the softer first fabric. In the example described above, the stiff second fabric has 30% more stiffness in the width direction and 60% more stiffness in the length direction than the soft first fabric.

It appears that adequate combinations of fabrics can be provided as a garment by using a second fabric that has at least approximately 15% more stiffness than a first fabric, where the first fabric forms the basic garment and the second fabric provides support elements or structure for key features of the basic garment formed by the first fabric. In general, this means that the stiffness differential between the stiff fabric and the soft fabric should be at least approximately 15% in both the warp and the weft. Various combinations of soft and stiffer fabrics can yield different results.

It is important to include both the average bending width and average bending length measurements as the warp and weft of a particular fabric can significantly affect the stiffness properties along each of those measurements. For example, leather has a natural grain which can greatly affect these measurements.

The collar support 20 seen in all three figures allows for additional collar, lapel, or surrounding neck construction that would normally be accomplished with some kind of synthetic or non-synthetic canvas or fabric adhesive that would be fusible on the interior of the two collar panels. The collar support 20 is made from leather or another fabric that has more stiffness than the basic fabric of the garment, consistent with the standard described above. The collar support 20 may be sewed in place underneath the fabric collar of the garment. Further, a collar stand 25 may also be incorporated into the garment just below the collar to give additional support to the collar. These support pieces allow for a sharp collar shape having a sturdy construction and sharp contouring around the neck.

The stiff fabric can also be incorporated as a hidden placket 30 underneath the center front placket of the garment as seen in FIG. 1 to give structure to the front body of the garment. This feature masks the contours of the wearer's body while allowing for the left, right, and back sides to drape easily thereby showcasing the fluidity and any special nature of the main fabric which may otherwise be concealed by canvassing or fusing. This hidden placket panel 30 is a central support beam for the entire body of the garment.

An additional cuff support 40 can be incorporated underneath of the cuffs which in turn keeps the entirety of the sleeve and armhole looking clean without being stiff. The sleeves of the garment drape downwards towards the cuff keeping an overall clean appearance due to the cuff support 40 at the end of the arm.

Overall the resulting garment has more maneuverability and the enhanced comfort of an unstructured garment while maintaining the clean appearance of a garment which would normally be much stiffer, more expensive to manufacture, and harder to clean without additional issues arising. The unique ability to showcase the drape of a soft fabric while still providing a structural skeleton to the garment is another added benefit of this unique system of construction.

1. A garment, comprising:
a first fabric; and
at least one support piece formed of a second fabric and affixed with a selected portion of the first fabric, the second fabric is stiffer than the first fabric.

2. The garment of claim 1, further comprising:
the first fabric is a soft fabric, and the second fabric is a stiff fabric.

3. The garment of claim 2, further comprising:
the second fabric is stiffer than the first fabric by at least approximately fifteen percent.

4. The garment of claim 2, further comprising:
the second fabric is at least approximately fifteen percent stiffer than the first fabric in a width direction and at least approximately fifteen percent stiffer than the first fabric in a length direction.

5. The garment of claim 1 including a collar, the support piece comprising:
a collar support formed of the second fabric and affixed with the collar.

6. The garment of claim 3, the support piece comprising:
a collar stand formed of the second fabric and affixed with the collar and the collar support.

7. The garment of claim 1, further comprising:
a placket; and
a placket support formed of the second fabric and affixed under the placket.

8. The garment of claim 1, further comprising:
a pair of cuffs each formed at sleeve ends; and
a pair of cuff supports each formed of the second fabric and each affixed under a respective one of the pair of cuffs.

9. A garment, comprising:
a first fabric; and
at least one support element formed of a second fabric and affixed with a selected portion of the first fabric, the second fabric is at least approximately fifteen percent stiffer than the first fabric.

10. The garment of claim 9, further comprising:
the second fabric is at least approximately fifteen percent stiffer than the first fabric in a width direction and at least approximately fifteen percent stiffer than the first fabric in a length direction.
